(19) United States
(12) Patent Application Publication
(10) Pub. No.: US 2006/0148490 A1
(43) Pub. Date: Jul. 6, 2006

(54) METHOD AND APPARATUS FOR DYNAMICALLY ALTERING THE OPERATIONAL CHARACTERISTICS OF A WIRELESS PHONE BY MONITORING THE PHONE'S MOVEMENT AND/OR LOCATION

(75) Inventors: Cary Lee Bates, Rochester, MN (US); Paul Reuben Day, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 10/905,437

(22) Filed: Jan. 4, 2005

(51) Int. Cl. H04Q 7/20

(52) U.S. Cl. 455/456.1

(57) ABSTRACT

A method, apparatus and program product for dynamically altering the behavior of a wireless phone based on the movement and/or location of the phone is provided. The present invention further provides caller-initiated control over the behavior of a wireless phone.

### FIELD OF THE INVENTION

The present invention relates generally to wireless communications, and more specifically to the dynamic alteration of the operation of a wireless phone by monitoring the phone's movement and/or location.

### BACKGROUND OF THE INVENTION

Cellular phone usage in the United States has reached a critical mass, with almost two-thirds of American adults now owning a cellular phone, according to a recent study from Scarborough Research. This represents a 29% growth rate of cellular phone ownership over the past two years. This growth is likely to continue, since 9% of American adults plan to purchase a cell phone in the next year.

Accompanying the growth of the usage of cellular phones is a corresponding growth in problems associated with their use. Foremost among these problems is the association between cellular phone calls and motor vehicle operational mishaps. In a recent study in the New England Journal of Medicine, Volume 336:453-458, Feb. 13, 1997, Number 7, entitled “Association between Cellular-Telephone Calls and Motor Vehicle Collisions”, phone records of 699 drivers who had cellular telephones and who were involved in motor vehicle collisions were studied. The study revealed that the risk of collision when a driver was using a cellular telephone was between 3 and 6.5 times higher than the risk when a cellular telephone was not being used. The relative risk was similar for drivers who differed in personal characteristics such as age and driving experience. The study further states that the relative risk was similar to that of driving when a blood-alcohol level is at the legal limit, and that cellular phones that allowed hands-free operation offered no safety advantage.

On Dec. 1, 2001, New York became the first state to ban handheld cellular phones when driving. Thirty-five other states are considering similar legislation. In addition, several towns in Florida, Massachusetts, New Jersey, New Mexico, Ohio, Pennsylvania, and Utah have enacted bans, as have about 20 countries. All of the bans in the U.S. and the vast majority of the legislation target only handheld cell phones, allowing people to use hands-free phones while driving. Accumulating evidence, though, suggests that simply talking on a telephone—not just dialing or holding a receiver—can seriously impair a driver and should be restricted to people who are not actually driving. This problem can be especially acute in young, inexperienced drivers.

Another problem associated with the dramatic increase in cellular phone usage is the disruption that occurs when such phones are used at an inappropriate time and/or location, unbeknownst to the caller. Almost everyone has experienced the annoyance of a cellular phone ringing during a movie, during a class, or at a church service. Cell phone calls received at seemingly “normal” times can disrupt sleep patterns of individuals that work unusual hours, or are temporarily in a shifted sleep window.

While cellular phone users always have the option of turning off their phones during sensitive times, or when the users are in sensitive locations, this is not always practical. Users can often forget to turn off their phones, or retrieve their phone messages, once their phones are turned back on. In this way, important time-sensitive messages may be lost or deferred past the point of usefulness.

There is a need to dynamically alter the behavior of a wireless phone based on the movement and/or location of the phone. It would also be desirable to provide caller initiated control over the behavior of a wireless phone.

### SUMMARY OF THE INVENTION

In one embodiment of the present invention, a method is provided for dynamically changing an operational characteristic of a wireless phone. The method periodically monitors the wireless phone for motion, then changes the operational characteristic of the wireless phone based upon the monitored motion. The changing of the operational characteristic includes: 1) determining if the wireless phone has been in motion for at least a first predetermined time period; 2) disabling the ringing of the phone upon an incoming call if the phone has been in motion for a time exceeding the first predetermined time period; and optionally 3) re-enabling the ringing of the wireless phone if the wireless phone has been stationary for a time exceeding a second predetermined time period following the disabling. In one embodiment, the identity is captured of the person making the call to the wireless phone, then connecting the person making the incoming call with the holder of the wireless phone if the wireless phone has been stationary for a time exceeding a second predetermined time period following the disabling.

In another embodiment of the present invention, a method is provided for dynamically changing an operational characteristic of a wireless phone, wherein the method periodically monitors the wireless phone for locational indicia, then changes the operational characteristic of the wireless phone based upon the locational indicia and the intention of the caller initiating a call to the holder of the wireless phone.

In a first embodiment, the changing of the operational characteristic includes: 1) determining if the wireless phone has been in motion for at least a first predetermined time period; 2) disabling the ringing of the wireless phone upon an incoming call if the phone has been in motion for a time exceeding the first predetermined time period and the intention of the caller is to not ring the wireless phone while the phone is in motion; and optionally 3) re-enabling the ringing of the wireless phone if the wireless phone has been stationary for a time exceeding a second predetermined time period following the disabling. In one embodiment, the identity is captured of the person making the call to the wireless phone, then connecting the person making the incoming call with the holder of the wireless phone, if the wireless phone has been stationary for a time period exceeding a second predetermined time period following the disabling.

In a second embodiment, the changing of the operational characteristic includes: 1) determining if the wireless phone has been stationary for at least a first predetermined time period; 2) disabling the ringing of the wireless phone upon an incoming phone if the phone has been stationary for a time exceeding the first predetermined time period and the intention of the caller is to not ring the wireless phone while the phone is stationary; and optionally 3) re-enabling the ringing of the wireless phone if the wireless phone has been in motion for a time exceeding a second predetermined time period following the disabling.

In a third embodiment, the changing of the operational characteristic includes: 1) determining if the locational indicia indicates that the wireless phone resides within a predefined restricted access zone; 2) disabling the ringing of the phone for the call if the phone currently resides within the restricted access zone and the intention of the caller is not to ring the wireless phone while the wireless phone resides within the restricted access zone; and optionally 3) re-enabling the ringing of the wireless phone if the wireless phone no longer resides within the restricted access zone.

In a fourth embodiment, the changing of the operational characteristic includes: 1) determining if the locational indicia indicates that the wireless phone resides within a predefined permitted access zone; 2) enabling the ringing of the phone for the call if the phone currently resides within the permitted access zone and the intention of the caller is to ring the wireless phone only while the wireless phone resides within the permitted access zone; and 3) disabling the ringing of the wireless phone if the wireless phone no longer resides within the permitted access zone.

The present invention further provides an apparatus for changing an operational characteristic of a wireless phone. The apparatus includes a position detector for determining a set of locational indicia for the wireless phone, a memory for storing a call routing program, and a processor for executing the call routing program. The call routing program is configured to: 1) receive an incoming call; 2) determine an originating phone number for the incoming call; 3) compare the originating phone number against a set of controlling phone numbers associated with the wireless phone to determine if the call is originating from a controlling phone; 4) compare the set of locational indicia from the wireless phone against a set of predefined locational/movement restrictions to determine if the wireless phone is currently restricted from receiving the call; and 5) defer the routing of the call to the wireless phone if the call is originating from a controlling phone if the wireless phone is currently restricted from receiving the call. In alternate embodiments, the call routing program may reside either within the wireless phone, or within a call center server of a wireless phone service provider.

The foregoing and other features and advantages of the invention will be apparent from the following more particular description of preferred embodiments of the invention, as illustrated in the accompanying drawings.

### BRIEF DESCRIPTION OF THE DRAWINGS

FIG. 1A is a flow diagram of a method to change an optional characteristic of a wireless phone, wherein the wireless phone has been in motion for at least a predetermined time period;

FIG. 1B is a flow diagram of a method to disable the ringing of a wireless phone, wherein the wireless phone has been stationary for at least a predetermined time period;

FIG. 2A is a flow diagram of a method to disable the ringing of a wireless phone, wherein the wireless phone has been in motion for at least a predetermined time period, and the intention of the caller is to not ring the phone if the phone is in motion;

FIG. 2B is a flow diagram of a method to disable the ringing of a wireless phone, wherein the wireless phone has been stationary for at least a predetermined time period, and the intention of the caller is to not ring the phone if the phone is stationary;

FIG. 3 is a flow diagram of a method to disable the ringing of a wireless phone, wherein the wireless phone currently resides within a restricted zone and the intention of the caller is to not ring the phone if the phone is in a restricted zone;

FIG. 4 is a simplified block diagram of one embodiment of a wireless phone in accordance with the present invention;

FIG. 5 is a simplified block diagram of a wireless phone network in accordance with the present invention; and

FIG. 6 is an embodiment of a call center database, as shown previously in FIG. 5.

### DETAILED DESCRIPTION OF THE PREFERRED EMBODIMENTS

Turning to the Drawings, wherein like numbers denote like parts throughout the several views, the present invention provides methods and an apparatus to dynamically alter the behavior of a wireless phone based on the movement and/or location of the phone. The present invention further provides caller-initiated control over the behavior of a wireless phone.

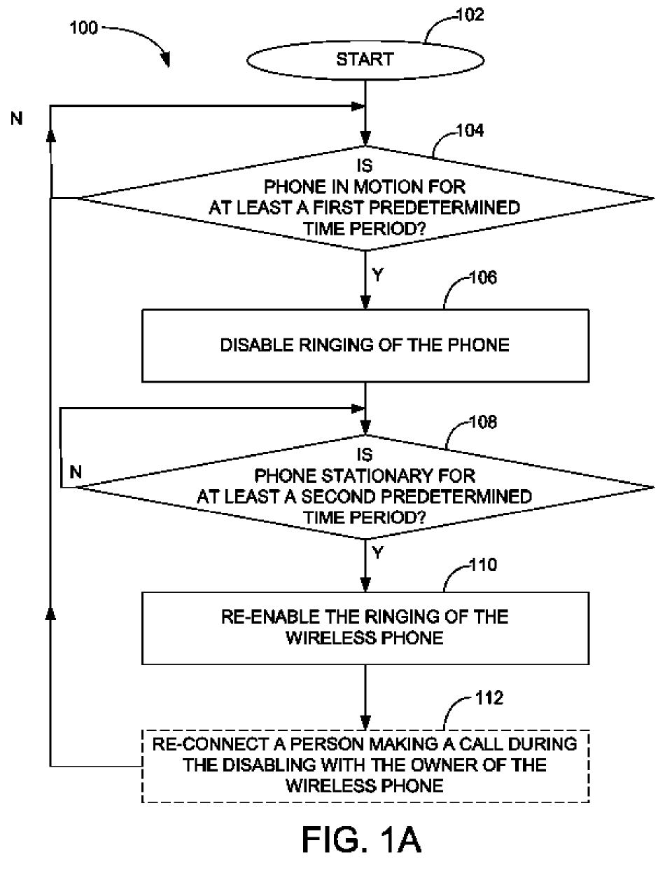

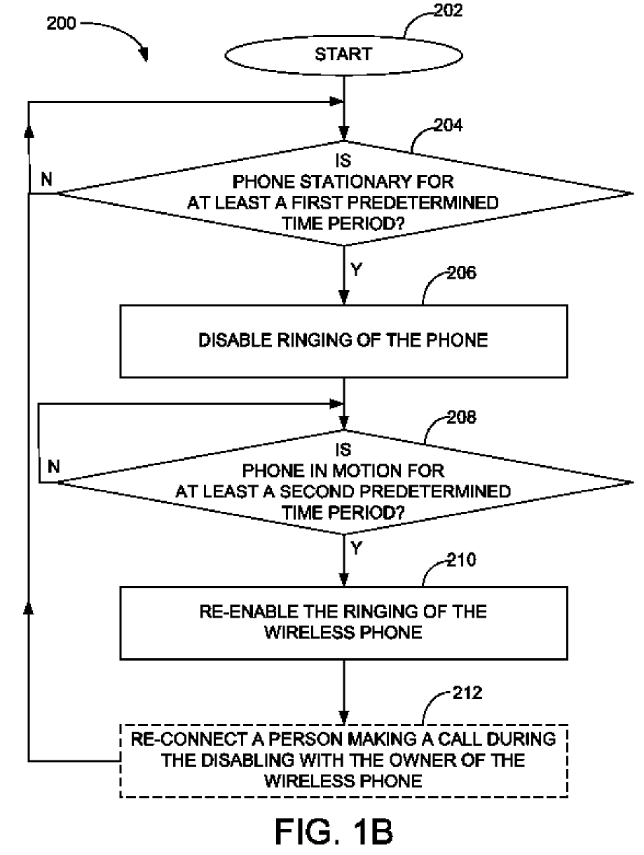

FIG. 1A provides flow diagram of a method to change an operational characteristic of a wireless phone, wherein the wireless phone has been in motion for at least a predetermined time period, shown generally at 100. Such a method is useful in a number of scenarios. For example, suppose a person is driving and does not wish to be interrupted. The activation of this method in a wireless phone would enable the wireless phone holder to defer the call until the holder of the wireless phone is no longer driving the vehicle.

The method begins at block 102. At block 104, it is determined if a wireless phone is in motion for at least a first predetermined time period (e.g., 2 minutes). A variety of methods may be employed for determining whether the wireless phone is in motion. In one embodiment, the wireless phone may employ a built in global positioning system (GPS) receiver to determine the motion (e.g., determining a change in GPS coordinates over a predetermined sampling period). In another embodiment, cellular tower triangulation may be used to determine if the wireless phone is in motion. In yet another embodiment, an inertial motion sensor may be employed to determine movement. In some instances, it may be advantageous to disregard a temporary suspension in the motion of the phone (e.g., the phone is in a vehicle which is stopped at a traffic light for a brief time interval). In this instance, the phone will be considered to be “in motion” unless the phone is stationary for at least a second predetermined time period. In one embodiment, there may also be a “threshold” for the amount of motion. In other words, the wireless phone will only be deemed to be in motion if the phone is moving greater than a threshold speed (e.g., 10 miles per hour). In this way, it may be possible to distinguish the type of movement (i.e., vehicle movement vs. walking/running). It is also contemplated that an “override” control may exist which would enable the holder of the wireless phone to disable the motion sensing feature if the holder of the phone is not controlling (i.e., driving) the vehicle in motion (e.g., a passenger in a car, bus, train or plane).

If the phone has not been in motion for at least a first predetermined time period, control passes back to block 104, where this condition is periodically re-tested. The predetermined time period may be defined by several parties (e.g., the wireless phone provider, the person carrying the wireless phone, a parent of the carrier of the wireless phone, etc.). If the phone is determined to be in motion for at least a first predetermined time period, control passes to block 106, wherein the ringing of the phone is disabled for subsequent received calls. In one embodiment, the phone number of the caller is captured, so that the call may be re-established once the holder of the wireless phone is stationary.

At block 108, it is determined if the phone is stationary for at least a second predetermined time period. This second predetermined time period may be defined by several parties (e.g., the wireless phone provider, the carrier of the wireless phone, a parent of the carrier of the wireless phone, etc.). This test is performed to determine the threshold at which a wireless phone passes from a “in motion” state to a “stationary” state. If the phone has not been stationary for the second predetermined time period, control passes back to block 108, where this condition is periodically re-tested. If the phone is determined to be stationary for at least a second predetermined time period, control passes to block 110, wherein the ringing of the wireless phone is re-enabled for subsequent received calls. At optional block 112, the holder of the wireless phone is connected with any persons making calls during the disabling period (i.e., when the phone was determined to be “in-motion”). In another option (not shown), instead of connecting directly, the present invention may allow for a notification to the both the originator and the recipient of the deferred call, so that either party can re-initiate contact with the other party at their convenience. Upon completion of this connection, control passes back to block 104.

FIG. 1B illustrates the converse situation of FIG. 1A, namely, disabling the ringing of a wireless phone, wherein the wireless phone has been stationary for at least a predetermined time period, shown generally at 200. One example scenario where such a method would prove useful is when a wireless phone holder is resting/sleeping and does not wish to be disturbed.

The method begins at block 202. At block 204, it is determined if a wireless phone is stationary for at least a first predetermined time period (e.g., 2 hours). As described above, a variety of methods may be employed for determining whether the wireless phone is in motion or is stationary, including, but not limited to: GPS, wireless phone tower translation, and an inertial motion sensor.

If the phone has not been stationary for at least a first predetermined time period, control passes back to block 204, where this condition is periodically re-tested. If the phone is determined to be stationary for at least a first predetermined time period (i.e., the first predetermined period determined by the person carrying the phone, the wireless phone service provider, the parent of the person carrying the phone, etc.), control passes to block 206, wherein the ringing of the phone is disabled for subsequent received calls. In one embodiment, the phone number of the caller is captured, so that the call may be re-established or notification given once the holder of the wireless phone is stationary.

At block 208, it is determined if the phone has regained motion for at least a second predetermined time period (i.e., the second predetermined period determined by the person carrying the phone, the wireless phone service provider, the parent of the person carrying the phone, etc.). This test is performed to determine the threshold at which a wireless phone passes from a “stationary” state to an “in-motion” state. If the phone has not been in-motion for the second predetermined time period, control passes back to block 208, where this condition is periodically re-tested. If the phone is determined to be in-motion for at least a first predetermined time period, control passes to block 210, wherein the ringing of the wireless phone is re-enabled for subsequent received calls. At optional block 212, the holder of the wireless phone is connected with any persons making calls during the disabling period (i.e., when the phone was determined to be “stationary”). In another option (not shown), instead of connecting directly, the present invention may allow for a notification to the both the originator and the recipient of the deferred call, so that either party can re-initiate contact with the other party at their convenience. Upon completion of the connection, control passes back to block 204.

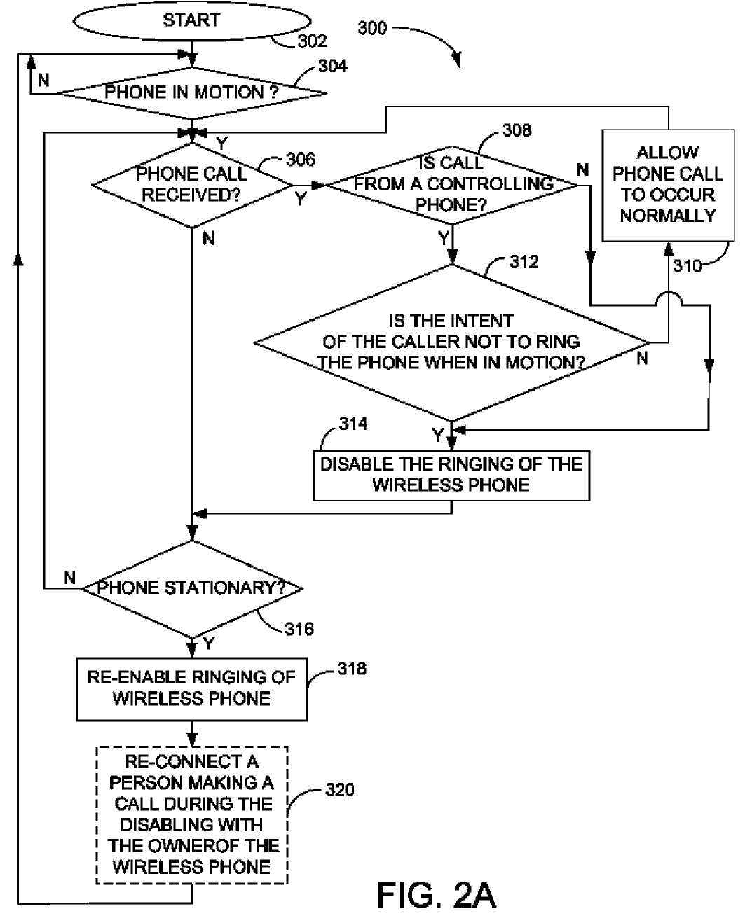

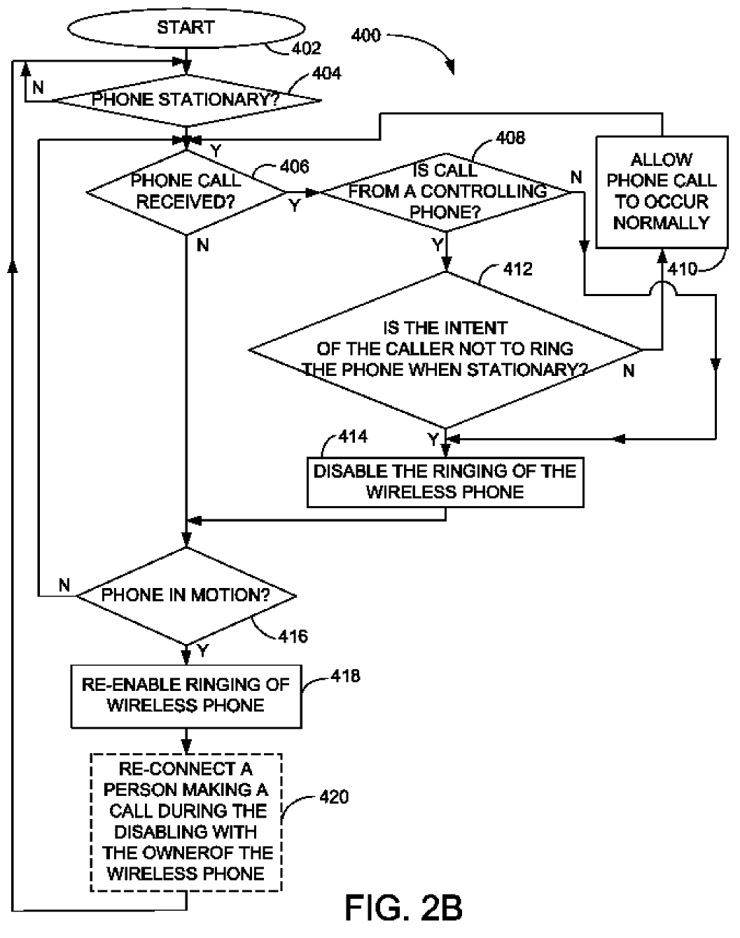

FIG. 2A provides a flow diagram of a method to disable the ringing of a wireless phone, wherein the wireless phone has been in motion for at least a predetermined time period and when the intent of the caller is not to disturb the recipient of the call if the recipient is currently in motion, shown generally at 300. There are several scenarios where the present method may prove useful. For example, suppose a parent does not wish to bother a teenage child while they are driving. The activation of this method within a wireless phone or alternatively, at the wireless phone service provider, would enable the parent of the mobile teenager to defer their call until the teenager holding the wireless phone is no longer driving the vehicle.

The method begins at block 302, wherein the phone assumes normal operation. At block 304, it is determined if a wireless phone is in motion for at least a first predetermined time period (e.g., 2 minutes). As previously described in FIG. 1A, a variety of methods may be employed for determining whether the wireless phone is in motion (e.g., GPS, wireless tower triangulation, inertial movement sensor, etc.). In some instances, it may be advantageous to disregard a temporary suspension in the motion of the phone (e.g., the phone is in a vehicle which is stopped at a traffic light for a brief time interval). In this instance, the phone will be considered to be “in motion” unless the phone is stationary for at least a second predetermined time period. In one embodiment, there may also be a “threshold” for the amount of motion. In other words, the wireless phone will only be deemed to be in motion if the phone is moving greater than a threshold speed (e.g., 10 miles per hour). In this way, it may be possible to distinguish the type of movement (i.e., vehicle movement vs. walking/running).

If the phone has not been in motion for at least a first predetermined time period, control passes back to block 304, where this condition is periodically re-tested (i.e., the phone is in “normal” operating mode with no restrictions on incoming calls). If the phone is determined to be in motion for at least a first predetermined time period, control passes to block 306, wherein it is determined if a phone call is received. If a phone call is not currently received, control passes to block 316. If a phone call is received, control passes to decision block 308, where it is determined if the current received call is from a “controlling phone” (i.e., a phone that is able to control at least one operational characteristic of a remote wireless phone).

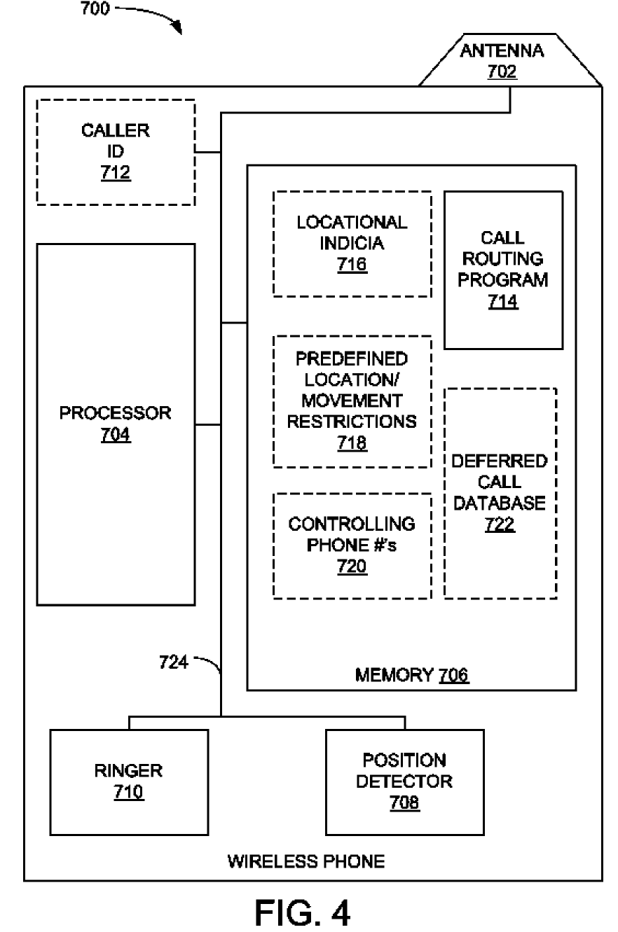

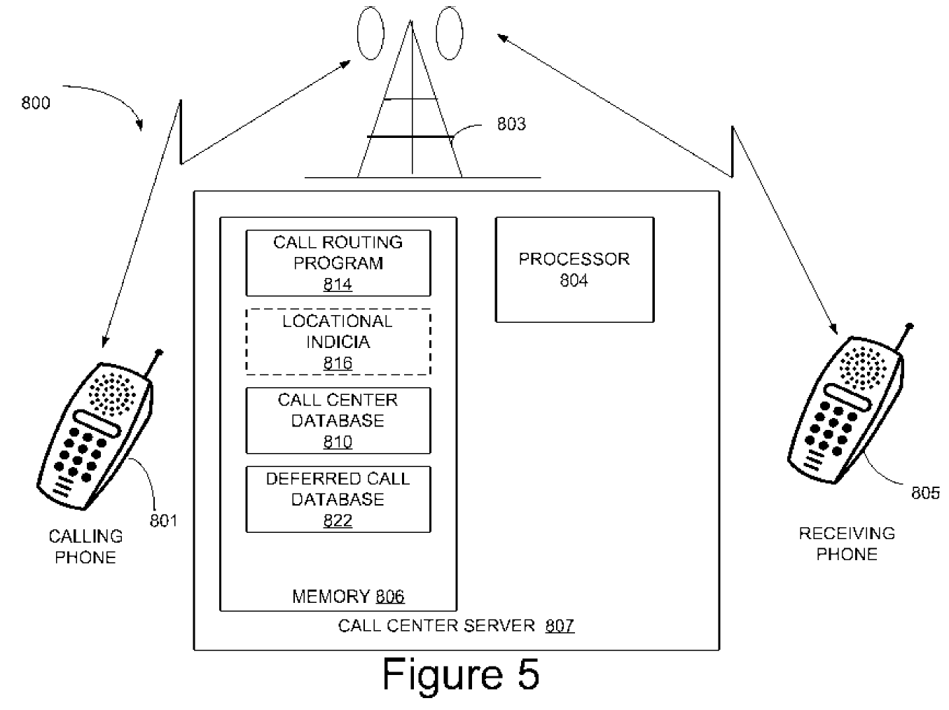

In one embodiment of the present invention, a list of one or more controlling phone numbers is associated with the wireless phone currently in motion. This list may reside within the wireless phone itself (shown subsequently in FIG. 4), or alternatively, may be stored at the wireless service provider (shown subsequently in FIG. 5). In the example scenario, the “controlling phone” would be the phone of the parent, and the “controlled phone” would be the phone of the teenager currently driving. Thus, only those phone calls originating from “controlling phones” would be able to control an operational feature (e.g., the ringing) of the remote wireless phone. Calls from non-controlling phones when the phone is in motion are automatically handled in a default fashion (e.g., the ringing of the phone is always disabled), as shown at block 314. If the phone call is from a controlling phone, control passes to decision block 312, where it is determined if the intent of the caller at the controlling phone is not to ring the controlled phone when the controlled phone is in motion.

In addition to the list of controlling phone numbers, the controlled wireless phone and/or the wireless service provider may also store an action/directive associated with the controlling phone identifier/number. For example, the controlling phone may control the ringing of the controlled phone if the controlled phone is in motion, if the controlled phone is stationary, if the controlled phone resides within a restricted zone, etc. These examples of actions/directives are provided for exemplary purposes only, and it is contemplated that a number of additional actions/directives may be performed and still remain within the scope and spirit of the present invention.

If it is not the intent of the caller of the controlling phone not to ring the controlled phone when the controlled phone is in motion, control passes to block 310, where the phone call is allowed to occur normally (i.e., the phone is allowed to ring). If it is the intent of the caller of the controlling phone is to not ring the controlled phone when the controlled phone is in motion, control passes to block 314, where the ringing of the wireless phone is disabled. In one embodiment, the phone number of the calling phone is retained for possible connection or notification to the receiver or to the caller when the controlled phone is no longer in motion.

At block 316, it is determined if the controlled wireless phone is stationary for at least a second predetermined time period. This test is performed to determine the threshold at which a wireless phone passes from a “in motion” state to a “stationary” state. If the phone has not been stationary for the second predetermined time period, control passes back to block 306. If the phone is determined to be stationary for at least a second predetermined time period, control passes to block 318, wherein the ringing of the wireless phone is re-enabled for subsequent received calls. At optional block 320, the holder of the wireless phone is re-connected with any persons making calls during the disabling period (i.e., when the phone was determined to be “in-motion”). In another option (not shown), instead of connecting directly, the present invention may allow for a notification to the both the originator and the recipient of the deferred call, so that either party can re-initiate contact with the other party at their convenience. Upon completion of the connection, control passes back to block 304.

FIG. 2B provides flow diagram of method to disable the ringing of a wireless phone, wherein the wireless phone has been stationary for at least a predetermined time period and when the intent of the caller is not to disturb the recipient of the call if the recipient is currently stationary, shown generally at 400. There are several scenarios where the present method may prove useful. For example, suppose a parent wishes to contact a son or daughter via their wireless phone at college. It is early in the morning, and the parents do not wish to wake their son or daughter. The son/daughter's wireless phone is resting in their back pack or some other location. In this scenario, the parents would like the wireless phone to ring when the son/daughter wakes up and begins moving around their dorm room but before they go to class.

The method begins at block 402, wherein the phone assumes normal operation. At block 404, it is determined if a wireless phone is stationary for at least a first predetermined time period (e.g., 2 hours). As previously described in FIG. 1A, a variety of methods may be employed for determining whether the wireless phone is stationary (e.g., GPS, wireless tower triangulation, inertial movement sensor, etc.). In some instances, it may be advantageous to disregard a temporary movement of the phone. In this instance, the phone will be considered to be “stationary” unless the phone is in motion for at least a second predetermined time period.

If the phone has not been stationary for at least a first predetermined time period, control passes back to block 404, where this condition is periodically re-tested (i.e., the phone is in “normal” operating mode with no restrictions on incoming calls). If the phone is determined to be stationary for at least a first predetermined time period, control passes to block 406, wherein it is determined if a phone call is received. If a phone call is not currently received, control passes to block 416. If a phone call is received, control passes to decision block 408, where it is determined if the current received call is from a “controlling phone”.

As mentioned previously, in one embodiment of the present invention, a list of one or more controlling phone numbers is associated with the wireless phone currently at rest. This list may reside within the wireless phone itself (shown subsequently in FIG. 4), or alternatively, may be stored at the wireless service provider (shown subsequently in FIG. 5). In the example scenario, the “controlling phone” would be the phone of the parent, and the “controlled phone” would be the phone of the teenager currently at rest. Thus, only those phone calls originating from “controlling phones” would be able to control an operational feature (e.g., the ringing) of the remote wireless phone. Calls from non-controlling phones when the phone is in motion are automatically handled in a default fashion (e.g., the ringing of the phone is always disabled), as shown at block 414.

If the phone call is from a controlling phone, control passes to decision block 412, where it is determined if the intent of the caller at the controlling phone is not to ring the controlled phone when the controlled phone is at rest.

In addition to the list of controlling phone numbers, the controlled wireless phone and/or the wireless service provider may also store an action/directive associated with the controlling phone identifier/number. For example, in this instance, the controlling phone may control the ringing of the controlled phone if the controlled phone is stationary.

If it is not the intent of the caller of the controlling phone to not ring the controlled phone when the controlled phone is stationary, control passes to block 410, where the phone call is allowed to occur normally (i.e., the phone is allowed to ring). If it is the intent of the caller of the controlling phone to not to ring the controlled phone when the controlled phone is stationary, control passes to block 414, where the ringing of the wireless phone is disabled. In one embodiment, the phone number of the calling phone is retained for possible connection or notification when the controlled phone is no longer stationary.

At block 416, it is determined if the controlled wireless phone is in motion for at least a second predetermined time period. This test is performed to determine the threshold at which a wireless phone passes from a “stationary” state to an “in motion” state. If the phone has not been in motion for the second predetermined time period, control passes back to block 406. If the phone is determined to be in motion for at least a second predetermined time period, control passes to block 418, wherein the ringing of the wireless phone is re-enabled for subsequent received calls. At optional block 420, the holder of the wireless phone is optionally re-connected with any persons making calls during the disabling period (i.e., when the phone was determined to be “stationary”). In another option (not shown), instead of connecting directly, the present invention may allow for a notification to the both the originator and the recipient of the deferred call, so that either party can re-initiate contact with the other party at their convenience. Upon completion of the connection, control passes back to block 404.

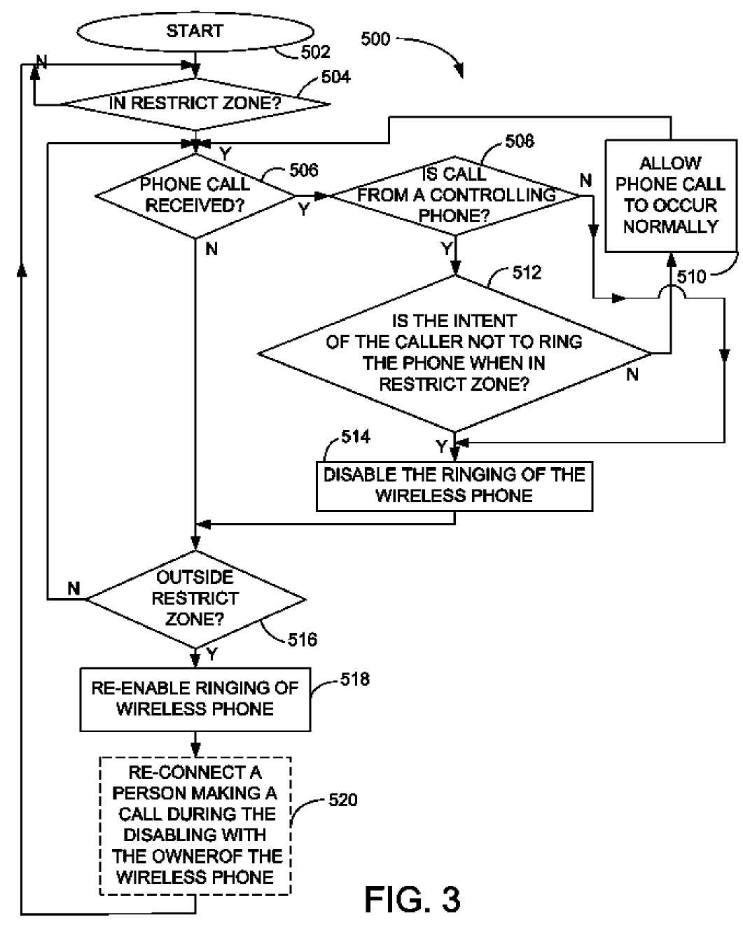

FIG. 3 provides flow diagram of a method to disable the ringing of a wireless phone when the intent of the caller is not to disturb the recipient of the call if the recipient is currently in a restricted access zone, shown generally at 500. Thus, while the flow diagrams of FIGS. 1-2 are directed toward modifying an operating condition of a wireless phone while the phone is in motion, FIG. 3 is directed toward modifying an operating condition of a wireless phone based on the location of the wireless phone and the intention of the caller.

There are several scenarios where the present method may prove useful. For example, suppose a parent wishes to call a child, but does not wish to disturb them if they are in or near a specific location (e.g., a church building, school, movie theater, etc.). The activation of this method within a wireless phone or alternatively, at the wireless service provider, would enable the parent of the mobile teenager to defer the call until the teenager holding the wireless phone is no longer within range of a specific location (i.e., is no longer in a restricted access zone).

The method begins at block 502, wherein the phone assumes normal operation (i.e., the phone is in “normal” operating mode with no restrictions on incoming calls). At block 504, it is determined if a wireless phone currently resides within a restricted access zone. The restricted access zone may be specified in a number of ways. In one example, one or more GPS coordinates for the restricted access zones may be provided to the wireless phone and/or service provider. In one example, the restricted access zone may be defined as the area defined by a center GPS coordinate and a predefined radius distance. There are a number of alternative ways to define the restricted access zones to the wireless phone/service provider and still remain within the scope and spirit of the present invention.

A variety of methods may be employed for determining the current location of the wireless phone (e.g., GPS, wireless tower triangulation, inertial movement sensor, etc.).

If the phone does not currently reside within a restricted access zone, control passes back to block 504, where this condition is periodically re-tested. If the phone is determined to reside within a restricted access zone, control passes to block 506, wherein it is determined if a phone call is received. If a phone call is not currently received, control passes to block 516. If a phone call is received, control passes to decision block 508, where it is determined if the current received call is from a “controlling phone”.

As described previously, a list of one or more controlling phone numbers is associated with the wireless phone currently positioned within the restricted access zone. This list may reside within the wireless phone itself (shown subsequently in FIG. 4), or alternatively, may be stored at the wireless service provider (shown subsequently in FIG. 5). In the example scenario, the “controlling phone” would be the phone of the parent, and the “controlled phone” would be the phone of the teenager currently driving. Thus, only those phone calls originating from “controlling phones” would be able to control an operational feature (e.g., the ringing) of the remote wireless phone. Calls from non-controlling phones when the phone is in motion are automatically handled in a default fashion (e.g., the ringing of the phone is always disabled), as shown at block 514.

If the phone call is from a controlling phone, control passes to decision block 512, where it is determined if the intent of the caller at the controlling phone is not to ring the controlled phone when the controlled phone resides within a restricted access zone.

If it is not the intent of the caller of the controlling phone to not to ring the controlled phone when the controlled phone is in a restricted access zone (i.e., the caller is not concerned about placing a call to a wireless phone currently residing within a restricted access zone), the phone call is allowed to occur normally, i.e., control passes to block 510). If it is the intent of the caller of the controlling phone to not ring the controlled phone when the controlled phone is in a restricted access zone, control passes to block 514, where the ringing of the wireless phone is disabled. In one embodiment, the phone number of the calling phone is retained for possible connection or notification when the controlled phone is no longer in motion.

At block 516, it is determined if the controlled wireless phone still resides within the restricted access zone. This test is performed to determine the threshold at which a wireless phone passes from a “restricted” state to a “non-restricted” state. If the phone still resides within the restricted access zone, control passes back to block 506. If the phone has been determined to no longer reside within the restricted access zone, control passes to block 518, wherein the ringing of the wireless phone is re-enabled for subsequent received calls. At optional block 520, the holder of the wireless phone is re-connected with any persons making calls during the disabling period (i.e., when the phone was determined to reside in a restricted access zone). In another option (not shown), instead of connecting directly, the present invention may allow for a notification to the both the originator and the recipient of the deferred call, so that either party can re-initiate contact with the other party at their convenience. Upon completion of the connection, control passes back to block 504.

In a minor variation of FIG. 3 (not illustrated), it may be desirable to enable the ringing of a wireless phone only when the recipient is currently in a permitted access zone. There are several scenarios where this might prove useful. For example, if all locations are restricted, by default, it is possible to restrict phone usage over large areas without having to program each restricted zone, as previously illustrated in FIG. 3. This feature also would enable a wireless phone user to more easily cut down on minutes used, if the phone is only activated in certain designated (i.e., permitted) locations. In yet another scenario, the wireless phone/service provider can automatically track the remaining minutes or remaining out of area minutes on the cell phone plan, then implement stage-wise restrictions to certain permitted areas when the minutes left on the plan are becoming constrained, such as at the end of the month.

It is contemplated that within the embodiments of FIGS. 2A, 2B and 3, the present invention may offer a feature to enable the controlling phone caller to override the disabling of the ringing of the wireless phone in the case of emergency.

FIG. 4 is a simplified block diagram of one embodiment of a wireless phone in accordance with the present invention, shown generally at 700. In the illustrated embodiment, wireless phone 700 includes a processor 704, memory 706, position detector 708, ringer 710, and an antenna 702, interconnected by a bus 724. Memory 706 further includes a call routing program 714 which implements at least one of the methods described above. Memory 706 may further include a call routing program 714, a locational indicia database 716, a predefined location/movement restriction database 718, a list of one or more controlling phone numbers 720, and a deferred call database 722.

The present invention may be implemented entirely within wireless phone 700, or alternatively, within the wireless phone service provider network (shown subsequently in FIG. 5). In the first instance, call routing program 714 executes on processor 704, continually monitoring the wireless phone for incoming calls, and also continuously monitoring the location and/or movement of the phone via position detector 708. This location and/or movement information is then optionally stored in a locational indicia area 716 in memory 706.

In a first example embodiment (previously shown in FIGS. 1A & 1B), when an incoming phone call is received at the wireless phone 700 via antenna 702, call routing program 714 determines an originating phone number for the incoming call. The call routing program then compares the movement of the phone against a set of predefined movement restrictions 718 stored in memory 706 in order to determine if the wireless phone is currently restricted from receiving the call. If this comparison determines that the phone is currently restricted, the ringer 710 is disabled, and the originating number for the incoming call is stored in deferred call database 722 for later reference. Call routing program 714 continues to monitor the movement of the phone via position detector 708, and when the phone is no longer restricted from receiving the call, call routing program uses deferred call database 722 to attempt to reestablish a connection with parties originating any deferred calls. In another option (not shown), instead of connecting directly, the present invention may allow for a notification to the both the originator and the recipient of the deferred call, so that either party can re-initiate contact with the other party at their convenience.

In a second example embodiment (previous shown in FIGS. 2A, 2B and 3), when an incoming phone call is received at the wireless phone 700 via antenna 702, call routing program 714 determines an originating phone number for the incoming call, then compares the incoming phone number against a set of controlling phone numbers 720 stored in the memory 706 of the wireless phone. If the call routing program 714 determines that the incoming call does not come from a controlling phone, the phone operates normally. If the call routing program 714 determines that the incoming call does come from a controlling phone, the call routing program next compares the current set of locational indicia 716 for the phone against a set of predefined location/movement restrictions 718 stored in memory 706 to determine if the wireless phone is currently restricted from receiving the call. If this comparison determines that the phone is currently in a restricted area, the ringer 710 is disabled, and the originating number for the incoming call is stored in deferred call database 722 for later reference. Call routing program 714 continues to monitor the position of the phone via position detector 708, and when the phone is no longer restricted from receiving the call, call routing program uses deferred call database 722 to attempt to reestablish a connection with parties originating any deferred calls. In another option (not shown), instead of connecting directly, the present invention may allow for a notification to the both the originator and the recipient of the deferred call, so that either party can re-initiate contact with the other party at their convenience.

FIG. 5 is a simplified block diagram of a wireless phone network 800 via a transmission tower 803, wherein the present invention is implemented within a call center server 807 of the wireless phone service provider. In a first example embodiment (previously shown in FIGS. 1A & 1B), when an incoming phone call is received at the call center server 807 via transmission tower 803, a call routing program 814 determines an originating phone number for a calling phone 801. The call routing program 814 then compares the movement of a receiving phone 805 against a set of predefined movement restrictions stored in memory 806 in order to determine if the receiving phone is currently restricted from receiving the call. If this comparison determines that the receiving phone 805 is currently restricted, the ringing of the receiving phone is disabled (e.g., by not forwarding the call to the receiving phone 805), and the originating number for the incoming call is stored in deferred call database 822 for later reference. Call routing program 814 continues to monitor the movement of the receiving phone, and when the receiving phone is no longer restricted from receiving the call, call routing program 814 uses deferred call database 822 to attempt to reestablish a connection with the parties or notify the parties of any deferred calls.

In a second example embodiment (previous shown in FIGS. 2A, 2B and 3), when an incoming phone call is received at the call center server 807 via transmission tower 803, call routing program 814 determines an originating phone number for the incoming call from calling phone 801, then compares the incoming phone number against a set of controlling phone numbers stored in the call center database 810. If the call routing program 814 determines that the incoming call does not come from a controlling phone, the phone operates normally. If the call routing program 814 determines that the incoming call does come from a controlling phone, the call routing program next compares the current set of locational indicia from the receiving phone 805 against a set of predefined location/movement restrictions 818 stored in memory 806 to determine if the wireless phone is currently restricted from receiving the call. If this comparison determines that the receiving phone 805 is currently in a restricted area, the ringing of the receiving phone 805 is disabled, and the originating number for the incoming call is stored in deferred call database 822 for later reference. Call routing program 814 continues to monitor the position of the receiving phone 801, and when the receiving phone is no longer restricted from receiving the call, call routing program uses deferred call database 822 to attempt to reestablish a connection with parties originating any deferred calls from calling phone 801, or notify the parties of any deferred calls.

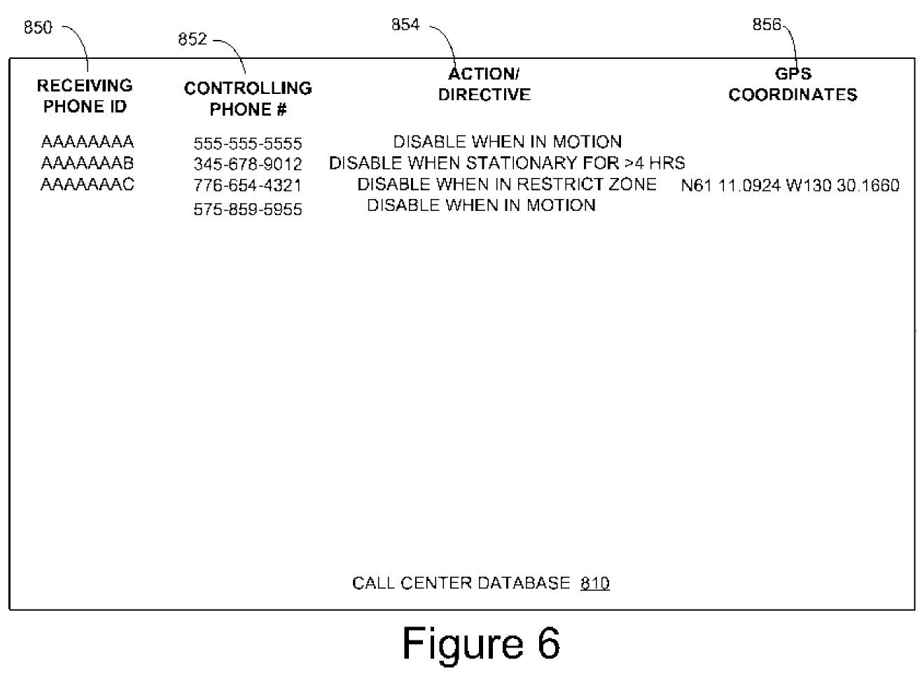

FIG. 6 is an embodiment of a call center database, as shown previously in FIG. 5, element 810. In the illustrated embodiment, an entry exists for each receiving phone identifier 850. Associated with each receiving phone id 850 is one or more controlling phone numbers 852. Associated with each controlling phone number 852 are one or more actions/directives, shown at 854. For example, calls intended at phone id “AAAAAAAA” from controlling phone number “555-555-5555” will be disabled, when phone “AAAAAAAA” is determined to be in motion. The illustrated database may also include one or more GPS coordinates 856 associated with a specific action/directive 854. For example, calls intended for receiving phone id “AAAAAAAC” from controlling phone number “776-654-4321” will not be allowed to occur when phone “AAAAAAAC” is in a restricted zone defined by GPS coordinate “N61 11.0924 W130 30.1660”. For example, a restricted zone may be defined as all locational coordinates existing within a predefined radius (e.g., one-tenth mile) of the provided GPS coordinate. There are a number of alternative ways to define restricted zone, and still remain within the scope and spirit of the present invention.

Although the present invention has been described in detail with reference to certain examples thereof, it may be also embodied in other specific forms without departing from the essential spirit or attributes thereof. For example, those skilled in the art will appreciate that the present invention is capable of being distributed as a program product in a variety of forms, and applies equally regardless of the particular type of signal bearing media used to actually carry out the distribution. Examples of suitable signal bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive, a CD-R disk, a CD-RW disk, or hard-disk drive); or (iii) information conveyed to a computer by a communications medium, such as through a computer or telephone network, including wireless communications, and specifically includes information downloaded from the Internet and other networks. Such signal-bearing media, when carrying computer-readable instructions that direct the functions of the present invention, represent embodiments of the present invention.

Embodiments of the present invention may also be delivered as part of a service engagement with a client company, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for the use of these methods and systems.

The invention in its broader aspects is therefore not limited to the specific details, representative apparatus and methods, and illustrated examples shown and described. Accordingly, departures may be made from such details without departing from the spirit or scope of applicants' general inventive concept. It is intended that the scope of the present invention be limited not by this detailed description, but rather by the claims appended hereto. Therefore, the invention lies in the claims hereinafter appended.

What is claimed is:

1. A method for dynamically changing an operational characteristic of a wireless phone, the method comprising the steps of:
periodically monitoring the wireless phone for motion; and
changing the operational characteristic of the wireless phone based upon the monitored motion.

2. The method of claim 1, wherein the step of changing the operational characteristic of the wireless phone based upon the monitored motion comprises the steps of:
determining if the wireless phone has been in motion for at least a first predetermined time period; and
disabling the ringing of the phone upon an incoming call if the phone has been in motion for a time exceeding the first predetermined time period.

3. The method of claim 2, wherein the method further comprises the step of:
re-enabling the ringing of the wireless phone if the wireless phone has been stationary for a time exceeding a second predetermined time period following the disabling.

4. The method of claim 2, wherein the method further comprises the steps of:
capturing the identity of the person making the incoming call; and
connecting the person making the incoming call with a holder of the wireless phone, if the wireless phone has been stationary for a time exceeding a second predetermined time period following the disabling.

5. The method of claim 2, wherein the method further comprises the steps of:
capturing the identity of the person making the incoming call; and
notifying both the party making the incoming call and a holder of the wireless phone of the incoming call, so that either party can re-initiate contact with the other party at their convenience.

6. The method of claim 1, wherein the step of changing the operational characteristic of the wireless phone based upon the monitored motion comprises the steps of:
determining if the wireless phone has been stationary for at least a first predetermined time period; and
disabling the ringing of the phone upon an incoming call if the phone has been stationary for a time exceeding the first predetermined time period.

7. The method of claim 6, wherein the method further comprises the step of:
re-enabling the ringing of the wireless phone if the wireless phone has been in motion for a time exceeding a second predetermined time period following the disabling.

8. The method of claim 6, wherein the method further comprises the steps of:
capturing the identity of the person making the incoming call; and
connecting the person making the incoming call with a holder of the wireless phone, if the wireless phone has been in motion for a time exceeding a second predetermined time period following the disabling.

9. The method of claim 6, wherein the method further comprises the steps of:
capturing the identity of the person making the incoming call; and
notifying both the party making the incoming call and a holder of the wireless phone of the incoming call, so that either party can re-initiate contact with the other party at their convenience.

10. A method for dynamically changing an operational characteristic of a wireless phone, the method comprising the steps of:
periodically monitoring the wireless phone for locational indicia; and
changing the operational characteristic of the wireless phone based upon the locational indicia and the intention of a caller initiating a call to a holder of the wireless phone.

11. The method of claim 10, wherein the step of changing the operational characteristic of the wireless phone based upon the locational indicia and the intention of a caller initiating a call to a holder of the wireless phone comprises the steps of:
determining if the wireless phone has been in motion for at least a first predetermined time period; and
disabling the ringing of the wireless phone upon an incoming call if the phone has been in motion for a time exceeding the first predetermined time period and the intention of the caller is to not ring the wireless phone while the phone is in motion.

12. The method of claim 11, wherein the method further comprises the step of:
re-enabling the ringing of the wireless phone if the wireless phone has been stationary for a time exceeding a second predetermined time period following the disabling.

13. The method of claim 11, wherein the method further comprises the steps of:
capturing the identity of the person making the incoming call; and
connecting the person making the incoming call with the holder of the wireless phone, if the wireless phone has been stationary for a time exceeding a second predetermined time period following the disabling.

14. The method of claim 11, wherein the method further comprises the steps of:
capturing the identity of the person making the incoming call; and
notifying both the party making the incoming call and a holder of the wireless phone of the incoming call, so that either party can re-initiate contact with the other party at their convenience.

15. The method of claim 11, wherein the method further comprises the step of:
enabling the caller to override the disabling of the ringing of the wireless phone in case of emergency.

16. The method of claim 10, wherein the step of changing the operational characteristic of the wireless phone based upon the locational indicia and the intention of a caller initiating a call to a holder of the wireless phone comprises the steps of:
determining if the wireless phone has been stationary for at least a first predetermined time period; and
disabling the ringing of the phone upon an incoming call if the phone has been stationary for a time exceeding the first predetermined time period and the intention of the caller is to not ring the wireless phone while the phone is stationary.

17. The method of claim 16, wherein the method further comprises the step of:
re-enabling the ringing of the wireless phone if the wireless phone has been in motion for a time exceeding a second predetermined time period following the disabling.

18. The method of claim 16, wherein the method further comprises the steps of:
capturing the identity of the person making the incoming call; and
connecting the person making the incoming call with the holder of the wireless phone, if the wireless phone has been in motion for a time exceeding a second predetermined time period following the disabling.

19. The method of claim 16, wherein the method further comprises the steps of:
capturing the identity of the person making the incoming call;
notifying both the party making the incoming call and a holder of the wireless phone of the incoming call, so that either party can re-initiate contact with the other party at their convenience.

20. The method of claim 10, wherein the step of changing the operational characteristic of the wireless phone based upon the locational indicia and the intention of a caller initiating a call to a holder of the wireless phone comprises the steps of:
determining if the locational indicia indicates that the wireless phone resides within a predefined restricted access zone; and
disabling the ringing of the phone for the call if the phone currently resides within the restricted access zone and the intention of the caller is not to ring the wireless phone while the wireless phone resides within the restricted access zone.

21. The method of claim 20, wherein the method further comprises the step of:
re-enabling the ringing of the wireless phone if the wireless phone no longer resides within the restricted access zone.

22. The method of claim 20, wherein the method further comprises the steps of:
capturing the identity of the person making the incoming call; and
connecting the person making the incoming call with the holder of the wireless phone, if the wireless phone no longer resides within the restricted access zone.

23. The method of claim 20, wherein the method further comprises the steps of:
capturing the identity of the person making the incoming call;
notifying both the party making the incoming call and a holder of the wireless phone of the incoming call, so that either party can re-initiate contact with the other party at their convenience.

24. The method of claim 10, wherein the step of changing the operational characteristic of the wireless phone based upon the locational indicia and the intention of a caller initiating a call to a holder of the wireless phone comprises the steps of:
determining if the locational indicia indicates that the wireless phone resides within a predefined permitted access zone; and
enabling the ringing of the phone for the call if the phone currently resides within the permitted access zone and the intention of the caller is to ring the wireless phone only while the wireless phone resides within the permitted access zone.

25. The method of claim 24, wherein the method further comprises the step of:
disabling the ringing of the wireless phone if the wireless phone no longer resides within the permitted access zone.

26. The method of claim 10, wherein the step of changing the operational characteristic of the wireless phone based upon the location indicia and the intention of the caller initiating a call to a holder of the wireless phone comprises the steps of:
determining if the locational indicia indicates that the wireless phone resides within a predefined restricted access zone;
determining if the amount of minutes remaining on the phone is at a depleted level; and
disabling the ringing of the wireless phone upon an incoming call if the phone resides within a predefined restricted access zone, and the amount of minutes remaining on the wireless phone is at a depleted level.

27. An apparatus for changing an operational characteristic of a wireless phone, the apparatus comprising:
a position detector for determining a set of locational indicia for the wireless phone;
a memory for storing a call routing program;
a processor, which upon executing the call routing program, is configured to:
receive an incoming call;
determine an originating phone number for the incoming call;
compare the originating phone number against a set of controlling phone numbers associated with the wireless phone to determine if the call is originating from a controlling phone;
compare the set of locational indicia from the wireless phone against a set of predefined locational/movement restrictions to determine if the wireless phone is currently restricted from receiving the call; and
defer the routing of the call to the wireless phone if the call is originating from a controlling phone and if the wireless phone is currently restricted from receiving the call.

28. The apparatus of claim 27, wherein the call routing program resides within the wireless phone.

29. The apparatus of claim 27, wherein the call routing program resides within a call center server of a wireless phone service provider.

30. An apparatus for changing an operational characteristic of a wireless phone, the apparatus comprising:
a position detector for determining a movement of the wireless phone;
a memory for storing a call routing program;
a processor, which upon executing the call routing program, is configured to:
receive an incoming call;
determine an originating phone number for the incoming call;
compare the movement of the wireless phone against a set of predefined movement restrictions to determine if the wireless phone is currently restricted from receiving the call; and
defer the routing of the call to the wireless phone wireless phone is currently restricted from receiving the call.

31. A method for deploying computing infrastructure, comprising integrating computer readable code into a computing system, wherein the code in combination with the computing system is capable of performing the following:
receiving an incoming wireless phone call from a calling phone destined for a receiving phone;
determining an originating phone number for the calling phone;
comparing the originating phone number of the calling phone against a set of controlling phone numbers associated with the receiving phone to determine if the call is originating from a controlling phone;
comparing a set of current locational indicia from the receiving phone against a set of predefined locational/movement restrictions to determine if the wireless phone is currently restricted from receiving the call; and
deferring the routing of the call to the receiving phone if the call is originating from a controlling phone and if the receiving phone is currently restricted from receiving the call.
